(19) United States
(12) Patent Application Publication
(10) Pub. No.: US 2023/0271427 A1
(43) Pub. Date: Aug. 31, 2023

(54) MEDICINE INFORMATION MARKING DEVICE

(71) Applicant: JVM CO., LTD., Daegu (KR)

(72) Inventor: Jun Ho KIM, Daegu (KR)

(73) Assignee: JVM CO., LTD., Daegu (KR)

(21) Appl. No.: 18/014,721

(22) PCT Filed: Jun. 15, 2021
(86) PCT No.: PCT/KR2021/007438

§ 371 Date: Jan. 5, 2023

(30) Foreign Application Priority Data
Jul. 6, 2020 (KR) 10-2020-0082555

(51) Int. Cl. B41J 2/22; A61J 1/10; A61J 7/00

(52) U.S. Cl. CPC B41J 2/22; A61J 1/10; A61J 7/0084

(57) ABSTRACT

A medicine information marking device according to an embodiment of the present invention is used in a medicine packaging apparatus which dispenses medicines from a medicine storage unit, in which the medicines are stored, on the basis of a medicine discharging request and then packages the dispensed medicines in a medicine packing paper so that the medicines are divided into single doses and dispensed in one-dose packages, wherein one of multiple information marking parts is selectively pressed and moved so as to mark predetermined information.

### TECHNICAL FIELD

The present invention relates to a medicine information marking device, and more particularly, to a medicine information marking device that enables information on medicines to be easily delivered to a patient or the like.

### BACKGROUND ART

Generally, a medicine packaging apparatus is a device that automatically packages medicines, which are stored in a medicine storage unit, for single doses in a medicine packing paper according to a patient's prescription.

Specifically, a medicine packaging apparatus is a apparatus that, when a prescription from a doctor or pharmacist is input into a computer at a hospital or pharmacy, automatically dispenses and collects corresponding medicines and allows the collected medicines for single doses to be separately packaged in a medicine packing paper and then discharged in one-dose packages.

In a medicine packaging apparatus, a plurality of medicine storage units, each in which various medicines are stored, are arranged and installed on a mounting table, medicines dispensed from a specific medicine storage unit according to a prescription are dispensed downward through a path, the dispensed medicines are collected in a hopper, and the medicines collected in the hopper are discharged to a lower side of the hopper so that the medicines can be sealed and packaged by a medicine packing paper.

Here, the medicine packing paper for packaging the medicines is unwound from a state of being wound around a paper tube in the form of a roll, moved to the lower side of the hopper to accommodate the medicines discharged from the hopper, and then moved to a sealing mechanism for sealing, wherein, before the medicine packing paper is moved to the lower side of the hopper to accommodate the medicines discharged from the hopper, the medicine packing paper accommodates the medicines in a state of being folded in half by a member called a triangular plate, and then is sealed by the sealing mechanism to be discharged to the outside.

Meanwhile, on the medicine packing paper in which medicines have been packaged, dosage information on the corresponding medicines is printed and provided to a medicine taker, and for example, a time of taking the medicines is printed as text such as morning, lunch, and evening and provided to the medicine taker.

In such text, it is often not easy to determine when to take the medicines depending on the medicine taker's condition, and as a result, the medicine taker may confuse the medicines to be taken, resulting in medicine-related accidents.

Therefore, there is an urgent need for research aimed at preventing the possibility of medicine-related accidents by easily and conveniently providing dosage information on medicines and the like, regardless of the medicine taker's condition.

### DISCLOSURE

### Technical Problem

The present invention is directed to providing a medicine information marking device in which, on a medicine packing paper in which medicines have been packaged, dosage information on the corresponding medicines and the like are marked as straight lines and the like of various colors with a pen that can express arbitrary color, and thus medicine-related accidents caused by confusion of medicines to be taken are prevented.

### Technical Solution

One aspect of the present invention provides a medicine information marking device, which is a device which is used in a medicine packaging apparatus which dispenses medicines from a medicine storage unit, in which the medicines are stored, on the basis of a medicine dispensing request and then packages the dispensed medicines in a medicine packing paper so that the medicines are divided into single doses and dispensed in one-dose packages, and which marks information on the medicines that are stated to be packaged in the medicine packing paper or information on the medicines that have been packaged in the medicine packing paper on the medicine packing paper, the medicine information marking device including a first information marking part and a second information marking part; an information marking support part configured to support the first information marking part and the second information marking part so that the first information marking part and the second information marking part are positioned on a path through which the medicine packing paper is transferred, wherein the information marking support part allows the second information marking part to be positioned below the first information marking part; an external force supply part configured to pressurize one of the first information marking part and the second information marking part so that the pressurized information marking part is brought into contact with the medicine packing paper, wherein the information marking part which is brought into contact with the medicine packing paper marks the information on the medicines that are stated to be packaged in the medicine packing paper or the information on the medicines that have been packaged in the medicine packing paper on the medicine packing paper; and a position moving part configured to move the information marking support part so that the external force supply part selectively pressurizes one of the first information marking part and the second information marking part.

The position moving part of the medicine information marking device may raise the information marking support part so that the selective pressurization by the external force supply part is implemented.

Each of the first information marking part and the second information marking part of the medicine information marking device may be a pen which can express arbitrary color and may include a pen core and a case that accommodates the pen core, and the external force supply part, in a state in which the case is accommodated in and supported by the information marking support part, may pressurize the pen core so that the pen core protrudes from the case and is exposed such that the pen core is brought into contact with the medicine packing paper.

Each of the first information marking part and the second information marking part of the medicine information marking device may further include an adjusting part that, when the pen core is exposed from an inside of the case to the outside, maintains the exposed state, and when the first information marking part and the second information marking part are inserted into the information marking support part, the information marking support part may separate the case and the adjusting part from each other so that a function of the adjusting part is lost.

Each of the first information marking part and the second information marking part of the medicine information marking device may further include an enclosing part which is disposed inside the case and surrounds the pen core so as to prevent the pen core from being dried and to increase its lifetime when there is no pressure applied by the external force supply part.

When the pen core is pressurized by the external force supply part, a state of the enclosing part of the medicine information marking device may be changed so that the pen core protrudes from the case and is exposed.

The medicine information marking device may further include a medicine packing paper support which is positioned on a line corresponding to the external force supply part and supports the medicine packing paper so that the information on the medicines is clearly marked by the pressurized information marking part on the medicine packing paper which is brought into contact with the pressurized information marking part when one of the first information marking part and the second information marking part is pressurized by the external force supply part, wherein, when the pressurized information marking part is brought into contact with the medicine packing paper, the medicine packing paper support is elastically changed in position by the pressurized information marking part to prevent the medicine packing paper from being cut.

### Advantageous Effects

According to a medicine information marking device according to the present invention, on a medicine packing paper in which medicines have been packaged, dosage information on the corresponding medicines and the like can be marked as straight lines and the like of various colors with a pen that can express arbitrary color, and thus it is possible to prevent medicine-related accidents caused by confusion of medicines to be taken.

Further, even when an amount of dosage information on medicines to be marked increases, it is possible to improve space efficiency in the medicine packaging apparatus by minimizing an increase in size of the device itself.

### DESCRIPTION OF DRAWINGS

FIG. 1 is a drawing illustrating a part of a medicine packaging apparatus including a medicine information marking device according to an embodiment of the present invention.

FIG. 2 is a drawing illustrating a medicine information marking device according to an embodiment of the present invention.

FIGS. 3 and 4 are drawings for describing information marking parts provided in a medicine information marking device according to an embodiment of the present invention.

FIGS. 5 to 12 are drawings for describing a process of implementing, by a medicine information marking device according to an embodiment of the present invention, the marking of information on medicines for a morning dose, lunch dose, evening dose, and dose before bedtime on a medicine packing paper in which medicines have been packaged.

### BEST MODES OF THE INVENTION

Provided is a medicine information marking device according to an embodiment of the present invention, which is a device which is used in a medicine packaging apparatus which dispenses medicines from a medicine storage unit, in which the medicines are stored, on the basis of a medicine dispensing request and then packages the dispensed medicines in a medicine packing paper so that the medicines are divided into single doses and dispensed in one-dose packages, and which marks information on the medicines that are stated to be packaged in the medicine packing paper or information on the medicines that have been packaged in the medicine packing paper on the medicine packing paper, the medicine information marking device including a first information marking part and a second information marking part; an information marking support part configured to support the first information marking part and the second information marking part so that the first information marking part and the second information marking part are positioned on a path through which the medicine packing paper is transferred, wherein the information marking support part allows the second information marking part to be positioned below the first information marking part; an external force supply part configured to pressurize one of the first information marking part and the second information marking part so that the pressurized information marking part is brought into contact with the medicine packing paper, wherein the information marking part which is brought into contact with the medicine packing paper marks the information on the medicines that are stated to be packaged in the medicine packing paper or the information on the medicines that have been packaged in the medicine packing paper on the medicine packing paper; and a position moving part configured to move the information marking support part so that the external force supply part selectively pressurizes one of the first information marking part and the second information marking part.

### Modes of the Invention

Hereinafter, specific embodiments of the present invention will be described in detail with reference to the accompanying drawings. However, the spirit of the present invention is not limited to the embodiments presented in this specification. Those skilled in the art who understand the spirit of the present invention may easily suggest other embodiments that fall within the scope of the present invention or other regressive inventions by adding, changing, or removing other elements within the scope of the same concept, and the other embodiments are also within the spirit of the present invention.

Further, components having the same function within the scope of the same concept appearing in the drawings of each embodiment will be described using the same reference numerals.

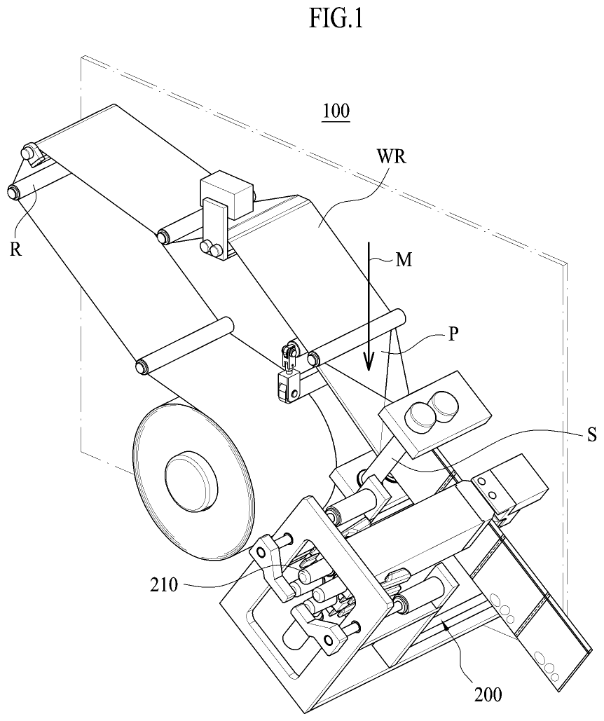

FIG. 1 is a drawing illustrating a part of a medicine packaging apparatus including a medicine information marking device according to an embodiment of the present invention.

Referring to FIG. 1, a medicine packaging apparatus 100 according to the present invention is a device in which medicines M are dispensed from medicine storage units (not illustrated), each in which various medicines are stored, on the basis of a medicine dispensing request (e.g., a patient's prescription or the like) and then the dispensed medicines M are packaged in a medicine packing paper WR so that the medicines M are divided into single doses and dispensed in one-dose packages.

In other words, the medicine packaging apparatus 100 is a device in which medicines M are dispensed from at least one medicine storage unit on the basis of a patient's prescription or the like, and when the medicines M are collected in a hopper (not illustrated) through a moving path, the medicines M collected in the hopper are introduced into a medicine packing paper WR and then the medicines M are packaged in single doses by being sealed by a sealing part S.

Here, the medicine packing paper WR for sealing and packaging the medicines M is unwound by power in a state of being wound in the form of a roll, and the unwound medicine packing paper WR is guided to be moved by at least one roller R and is folded in half by a triangular plate P having a triangular shape before reaching a position at which the medicines are introduced in order to accommodate the medicines M collected in the hopper.

The power to unwind the roll-type medicine packing paper WR may be provided by various components, and may be provided by, for example, a rotational force of the sealing part S for sealing.

When the medicine packing paper WR is folded in half by the triangular plate P, a space for accommodating the medicines M collected in the hopper is provided, and the medicines M collected in the hopper are moved down in the space and then are moved to a sealing position for being sealed by the sealing part S.

Before the medicine packing paper WR reaches the triangular plate P, information on medicines M that are stated to be packaged may be printed by a known printing unit (not illustrated), and the printed information on the medicines M may be various information such as types, quantity, taking time, patient name, hospital name, etc. of the medicines M that are stated to be packaged.

Meanwhile, the medicine packaging apparatus 100 according to the present invention may include a medicine information marking device 200 for marking the information on the medicines M that are stated to be packaged in the medicine packing paper WR or information on medicines M that have been packaged in the medicine packing paper WR on the medicine packing paper WR.

As illustrated in FIG. 1, the medicine information marking device 200 may be positioned on a downstream side of the triangular plate P and the sealing part S to mark the information on the medicines M that have been packaged in the medicine packing paper WR on the medicine packing paper WR, but the present invention is not limited thereto, and the medicine information marking device 200 may be positioned on an upstream side of the triangular plate P to mark the information on the medicines M that are stated to be packaged in the medicine packing paper WR on the medicine packing paper WR.

The medicine information marking device 200 is a device in which, on the medicine packing paper WR in which the medicines M have been packaged, dosage information indicating a time, at which the corresponding medicines will be taken, and the like are marked as straight lines or dotted lines of various colors with a pen that can express arbitrary color (hereinafter, for convenience of description, a case of being marked as straight lines will be described as an example), and thus medicine-related accidents caused by confusion of medicines to be taken are prevented.

Of course, even in the case of a medicine packaging apparatus in which the medicine information marking device 200 is omitted, although the above-described printing unit may inform the medicine packing paper of the dosage information on the corresponding medicines in text, it is often difficult to determine a time at which the medicines will be taken depending on the medicine taker's condition with such text, and as a result, the medicine taker may confuse the medicines to be taken, resulting in medicine-related accidents.

The above problems may be solved by the medicine information marking device 200 according to the embodiment of the present invention, and this will be described below in detail.

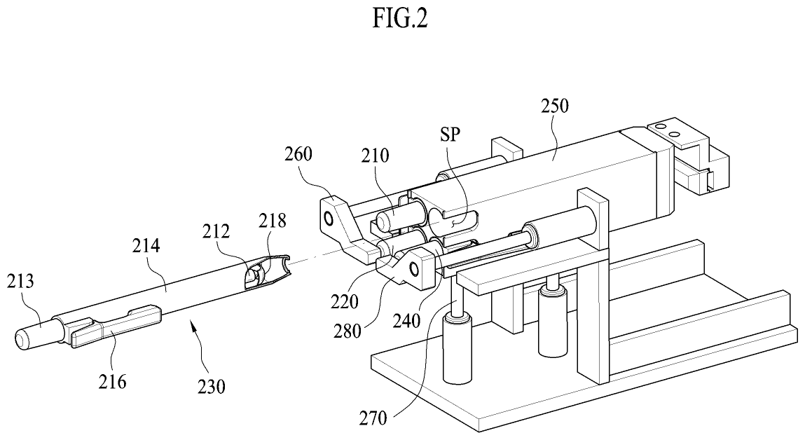

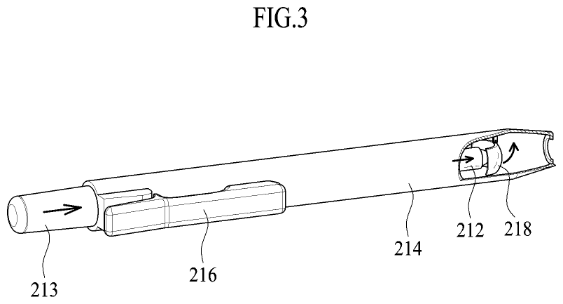

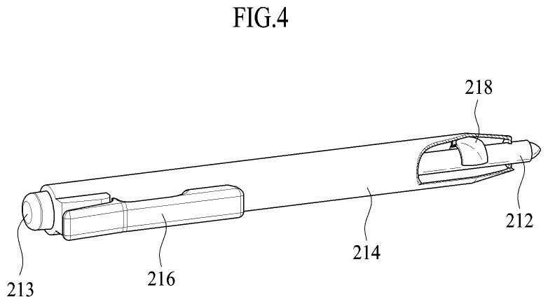

FIG. 2 is a drawing illustrating a medicine information marking device according to an embodiment of the present invention, and FIGS. 3 and 4 are drawings for describing information marking parts provided in the medicine information marking device according to the embodiment of the present invention.

Referring to FIGS. 2 to 4, a medicine information marking device 200 according to the embodiment of the present invention may include a first information marking part 210, a second information marking part 220, an information marking support part 250, an external force supply part 260, a position moving part 270, and the like.

Here, each off the first information marking part 210 and the second information marking part 220 is a pen which can express arbitrary color and may include a pen core 212 and a case 214 that accommodates the pen core 212.

Further, each of the first information marking part 210 and the second information marking part 220 may further include an adjusting part 216 that, when the pen core 212 is exposed from an inside of the case 214 to the outside, maintains the exposed state.

That is, each of the first information marking part 210 and the second information marking part 220 may be a pen in which, when a rear end 213 of the pen core 212 is pressurized, the pen core 212 is exposed and then the state in which the pen core 212 is exposed is maintained by the adjusting part 216.

Meanwhile, each of the first information marking part 210 and the second information marking part 220 may include an enclosing part 218 in which ink and the like of the pen core 212 is prevented from being dried when not in use to increase lifetime of the pen core 212.

The enclosing part 218 may cover the pen core 212 inside the case 214 before the pen core 212 is exposed to the outside of the case 214 to prevent the pen core 212 from communicating with the outside, and when the rear end 213 of the pen core 212 is pressurized, the enclosing part 218 may allow the pen core 21 to be exposed due to a state change such as rotation or the like.

The information marking support part 250 is a component that supports the first information marking part 210 and the second information marking part 220 so that the first information marking part 210 and the second information marking part 220 are positioned on a path through which the medicine packing paper WR is transferred, and may allow the second information marking part 220 to be positioned below the first information marking part 210.

The information marking support part 250 may include an insertion space SP into which the first information marking part 210 and the second information marking part 220 are inserted and fixed, and a total of four insertion spaces SP may be provided so that the first information marking part 210, the second information marking part 220, a third information marking part 230 disposed in parallel with the first information marking part 210, and a fourth information marking part 240 disposed in parallel with the second information marking part 220 are inserted therein as illustrated in FIG. 2.

That is, a total of four information marking parts 210, 220, 230, and 240 and insertion spaces SP may be disposed in a 2×2 configuration, but the present invention is not limited thereto, and the configuration of the information marking parts 210, 220, 230, and 240 and insertion spaces SP may be variously changed into one of 2×3 and 2×4 to 2×N (here, N is a natural number greater than or equal to 5) or into 1×2, 1×3, 1×4 to 1×N, etc. according to the number of pieces of dosage information to be marked on the medicine packing paper WR.

The external force supply part 260 is a component that pressurizes one of the first information marking part 210 and the second information marking part 220 so that the pressurized information marking part is brought into contact with the medicine packing paper WR, and may allow the information on the medicines M that are stated to be packaged in the medicine packing paper WR or the information on the medicines M that have been packaged in the medicine packing paper WR to be marked on the medicine packing paper WR by the information marking part which is brought into contact with the medicine packing paper WR.

The external force supply part 260 may pressurize the rear end 213 of the pen core 212 of one of the first information marking part 210 and the second information marking part 220 provided as a pen which can express arbitrary color to allow the pen core 212 to be exposed, and the exposed pen core 212 may be brought into contact with the moving medicine packing paper WR to mark a straight line or the like on the medicine packing paper WR so that the dosage information or the like may be known.

Meanwhile, the medicine information marking device 200 according to the present invention may include an additional external force supply part 280 for pressurizing one of the third information marking part 230 and the fourth information marking part 240 in addition to the external force supply part 260 for pressurizing one of the first information marking part 210 and the second information marking part 220.

The additional external force supply part 280 is the same component as the external force supply part 260 and has the same configuration and effect as the external force supply part 260 except for a target to be pressurized, and thus a description thereof will be replaced with the description of the external force supply part 260.

The position moving part 270 may be a component that moves the position of the information marking support part 250 to selectively pressurize the external force supply part 260 and one of the first information marking part 210, and the second information marking part 220.

The position moving part 270 may raise the information marking support part 250 so that the selective pressurization by the external force supply part 260 may be implemented.

Hereinafter, a principle of marking information on medicines on a medicine packing paper WR by a medicine information marking device 200 according to an embodiment of the present invention will be described in detail.

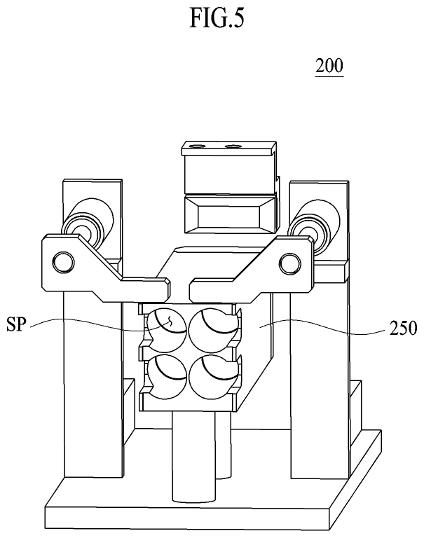

FIGS. 5 to 12 are drawings for describing a process of implementing, by a medicine information marking device according to an embodiment of the present invention, the marking of information on medicines for a morning dose, lunch dose, evening dose, and dose before bedtime on a medicine packing paper in which medicines have been packaged.

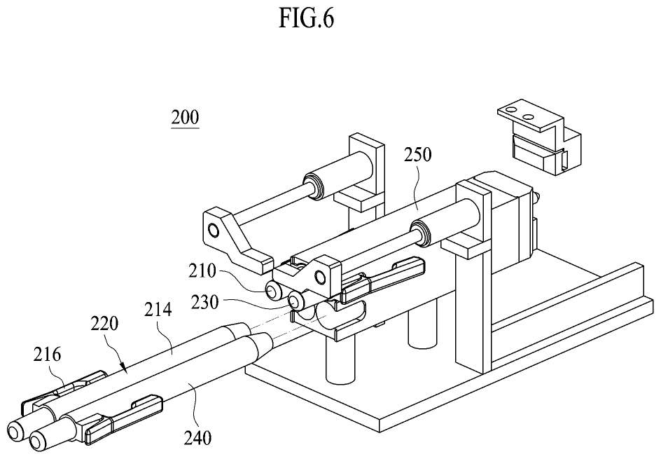

First, referring to FIGS. 5 and 6, in order to implement information on medicines M to be marked by a medicine information marking device 200 on a medicine packing paper WR, a first information marking part 210 to a fourth information marking part 240 may be inserted into an insertion space SP of an information marking support part 250.

Here, the insertion space SP may be provided in the form of, for example, a 2×2 configuration, the first information marking part 210 may marking a morning dose among pieces of dosage information, and a third information marking part 230 disposed in parallel with the first information marking part 210 may marking a lunch dose among the pieces of dosage information.

Further, a second information marking part 220 may marking an evening dose among the pieces of dosage information, and the fourth information marking part 240 may marking a dose before bedtime among the pieces of dosage information.

Of course, the first information marking part 210, the second information marking part 220, the third information marking part 230, and the fourth information marking part 240 may be provided as pens having different colors.

That is, the first information marking part 210, the second information marking part 220, the third information marking part 230, and the fourth information marking part 240 may be a red pen, a blue pen, a yellow pen, and a black pen, respectively, and may provide the information on the medicines, such as a time at which the medicines will be taken or the like, due to the color classification.

When the first information marking part 210 is inserted into the insertion space SP, the first information marking support part 250 may separate a case 214 of the first information marking part 210 and an adjusting part 216 from each other so that a function of the adjusting part 216, that is, a function of maintaining the pen core 212 in an exposed state, is lost.

In other words, when the first information marking part 210 is inserted into the insertion space SP, the adjusting part 216 may be positioned outside the insertion space SP, and the adjusting part 216 and the case 214 may be spaced apart from each other by a type of partition that defines the insertion space SP.

Here, the loss of the function by the adjusting part 216 may be equally applied to the second information marking part 220 to the fourth information marking part 240.

When the first information marking part 210 to the fourth information marking part 240 are inserted into the insertion space SP of the information marking support part 250, operation preparation of the medicine information marking device 200 is completed.

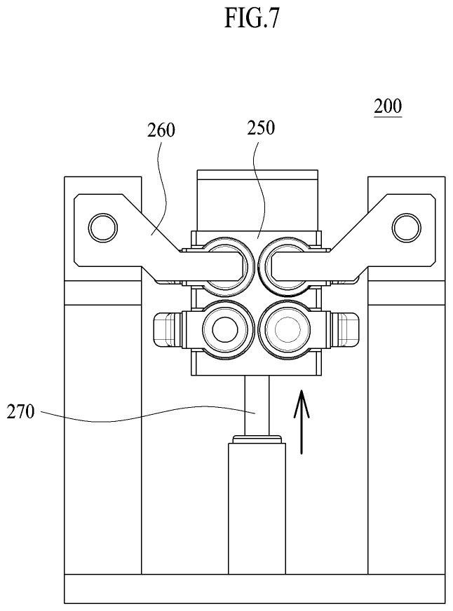

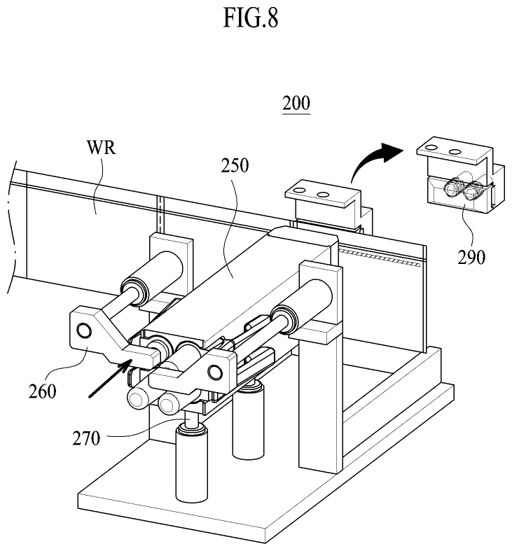

Referring to FIGS. 7 and 8, a medicine packaging apparatus 100 operates based on a medicine dispensing request so that the medicines are repeatedly packaged in single doses in the order of a morning dose, lunch dose, evening dose, and dose before bedtime.

First, in order to mark information on medicines for the morning dose, that is, a straight line indicating the morning dose, on a medicine packing paper WR corresponding to the morning dose, the information marking support part 250 may be raised as illustrated in FIG. 6.

The raising of the information marking support part 250 may be implemented by a position moving part 270, and the position moving part 270 may be implemented as a pneumatic cylinder, a hydraulic cylinder, a motor, or the like.

When the position moving part 270 is implemented as a motor, a component such as an eccentric means such as an eccentric cam or the like for changing the rotation of the motor into a vertical movement may be added between the information marking support part 250 and the position moving part 270.

When the information marking support part 250 is raised by the position moving part 270 so that the first information marking part 210 is raised to a position corresponding to the external force supply part 260, the external force supply part 260 operates, and as a result, a rear end of the first information marking part 210, that is, a rear end of the pen core 212, is pressurized.

The external force supply part 260, in a state in which the case 214 of the first information marking part 210 is accommodated in and supported by the information marking support part 250, may pressurize the pen core 212 so that the pen core 212 protrudes from the case 214 and is exposed such that the pen core 212 is brought into contact with the medicine packing paper WR corresponding to the morning dose.

The external force supply part 260 may be implemented as a pneumatic cylinder, a hydraulic cylinder, a motor, or the like, and when the external force supply part 260 is implemented as a motor, a component such as an eccentric means such as an eccentric cam or the like for changing the rotation of the motor into a vertical movement may be added.

When the rear end of the first information marking part 210 is pressurized by the external force supply part 260, the pen core 212 may be brought into contact with the moving medicine packing paper WR corresponding to the morning dose, and as a result, a red straight line is marked on the medicine packing paper WR corresponding to the morning dose (in FIG. 8, the red straight line is indicated by oblique hatching).

Here, a length of the straight line marked on the medicine packing paper WR corresponding to the morning dose may correspond to a time when the external force supply part 260 pressurizes the rear end of the first information marking part 210. However, when pressurization and non-pressurization are repeated, a dotted line may be marked instead of the straight line.

Meanwhile, when the first information marking part 210 is pressurized by the external force supply part 260, the medicine packing paper WR corresponding to the morning dose may be supported by a medicine packing paper support 290.

The medicine packing paper support 290 may be positioned on a line corresponding to the external force supply part 260 to allow the information on the medicines to be clearly marked by the first information marking part 210 on the medicine packing paper WR corresponding to the morning dose which is brought into contact with the first information marking part 210, and when the first information marking part is brought into contact with the medicine packing paper WR corresponding to the morning dose, the medicine packing paper support 290 may be elastically changed in position by the first information marking part 210 to prevent the medicine packing paper from being cut.

Even when the second information marking part 220, the third information marking part 230, and the fourth information marking part 240, which will be described below, operate, the medicine packing paper support 290 may exert the function of supporting the medicine packing paper WR, and a detailed description thereof will be omitted.

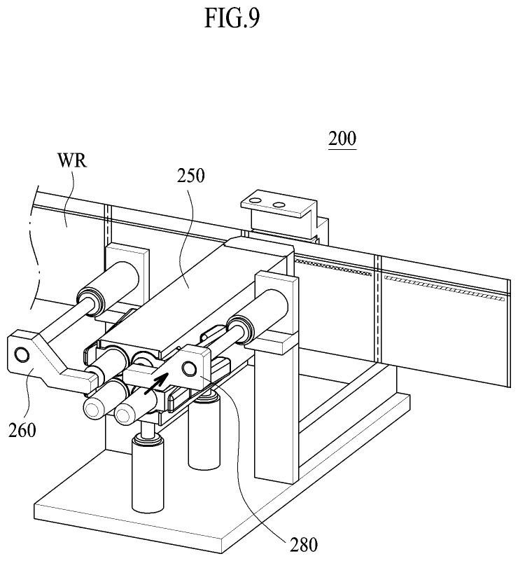

Referring to FIG. 9, when the marking of the information on the medicines by the first information marking part 210 on the medicine packing paper WR corresponding to the morning dose is completed, the external force supply part 260 returns to its original position.

When the pressurization applied by the external force supply part 260 is removed, the pen core 212 of the first information marking part 210 returns to its original position, and in this case, the pen core 212 can be prevented from being dried due to a state change of an enclosing part 218, and thus lifetime of the pen core 212 can be increased.

Next, in order to mark information on medicines for the lunch dose, that is, a straight line indicating the lunch dose, on a medicine packing paper WR corresponding to the lunch dose, a rear end of the third information marking part 230 is pressurized by the additional external force supply part 280.

A blue straight line indicating the lunch dose is marked on the medicine packing paper WR corresponding to the lunch dose by the pressurization by the additional external force supply part 280 (in FIG. 9, the blue straight line is indicated by X-shaped hatching).

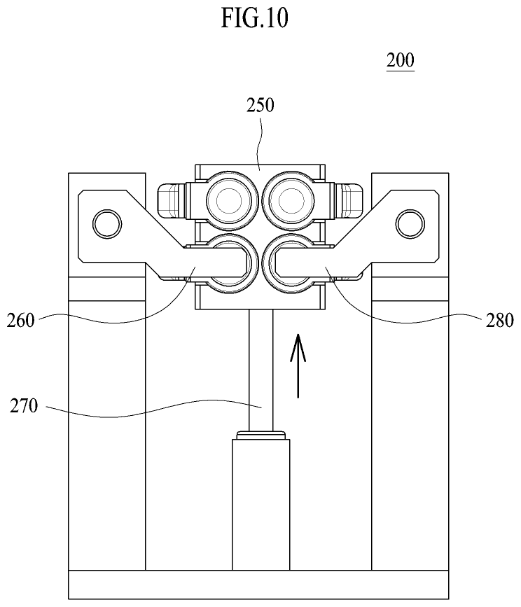

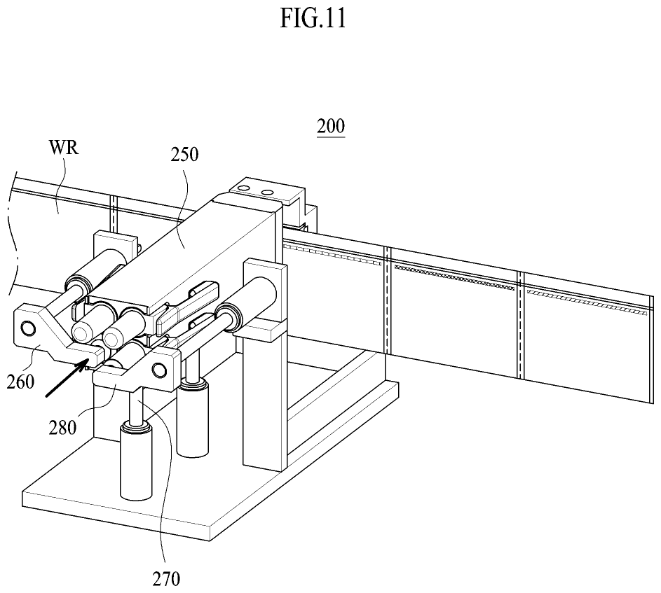

Next, referring to FIGS. 10 and 11, when the marking of the information on the medicines by the third information marking part 230 on the medicine packing paper WR corresponding to the lunch dose is completed, the additional external force supply part 280 returns to its original position.

Next, in order to mark information on medicines indicating the evening dose, that is, a straight line indicating the evening dose, on a medicine packing paper WR corresponding to the evening dose, the information marking support part 250 may be raised as illustrated in FIG. 9, and then, as illustrated in FIG. 10, a yellow straight line indicating the evening dose is marked on the medicine packing paper WR corresponding to the evening dose by the operation of the external force supply part 260 (in FIG. 10, the yellow straight line is indicated by parallel hatching).

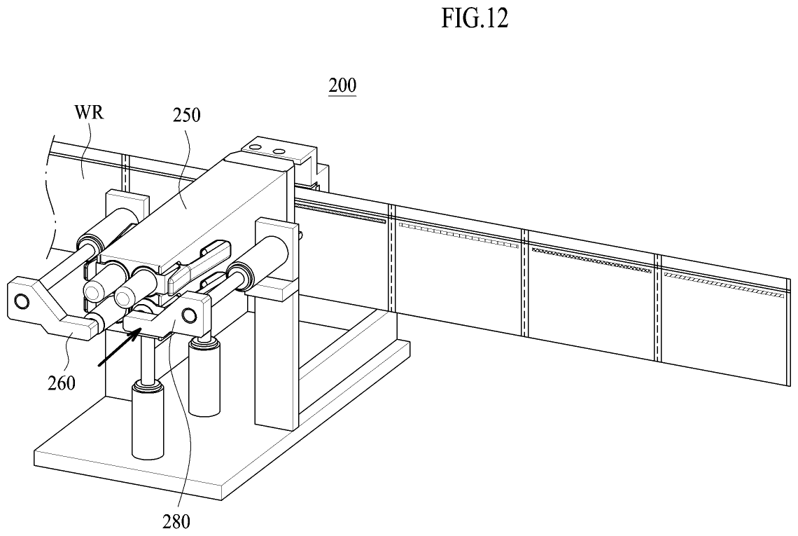

Referring to FIG. 12, when the marking of the information on the medicines by the second information marking part 220 on the medicine packing paper WR corresponding to the evening dose is completed, the external force supply part 260 returns to its original position.

Next, in order to mark information on medicines indicating the dose before bedtime, that is, a straight line indicating the dose before bedtime, on a medicine packing paper WR corresponding to the dose before bedtime, a rear end of the fourth information marking part 240 is pressurized by the additional external force supply part 280.

A black straight line indicating the dose before bedtime is marked on the medicine packing paper WR corresponding to the dose before bedtime by the pressurization by the additional external force supply part 280 (in FIG. 12, the black straight line is indicated by dotted hatching).

When the above operations are repeated, the marking of the information on the medicines for the morning dose, lunch dose, evening dose, and dose before bedtime on the medicine packing paper WR so as to correspond to the medicine dispensing request is repeatedly implemented in various colors.

In the present invention, the marking of the information on the medicines for the morning dose, lunch dose, evening dose, and dose before bedtime on the medicine packing paper WR is implemented by the raising of the information marking support part 250, and as compared to the conventional circular method, a volume of the medicine packaging apparatus 100 can be minimized, thereby maximizing the space efficiency in the medicine packaging apparatus 100.

Although the configuration and features of the present invention have been described with reference to embodiments of the present invention, the present invention is not limited thereto. In addition, those skilled in the art may easily change and modify the embodiments within the spirit and scope of the present invention and it will be clear that such changes or modifications fall within the scope of the appended claims.

1. A medicine information marking device, which is used in a medicine packaging apparatus which dispenses medicines from a medicine storage unit, in which the medicines are stored, on the basis of a medicine dispensing request and then packages the dispensed medicines in a medicine packing paper so that the medicines are divided into single doses and dispensed in one-dose packages, and which marks information on the medicines that are stated to be packaged in the medicine packing paper or information on the medicines that have been packaged in the medicine packing paper on the medicine packing paper, comprising:
a first information marking part and a second information marking part;
an information marking support part configured to support the first information marking part and the second information marking part so that the first information marking part and the second information marking part are positioned on a path through which the medicine packing paper is transferred, wherein the information marking support part allows the second information marking part to be positioned below the first information marking part;
an external force supply part configured to pressurize one of the first information marking part and the second information marking part so that the pressurized information marking part is brought into contact with the medicine packing paper, wherein the information marking part which is brought into contact with the medicine packing paper marks the information on the medicines that are stated to be packaged in the medicine packing paper or the information on the medicines that have been packaged in the medicine packing paper on the medicine packing paper; and
a position moving part configured to move the information marking support part so that the external force supply part selectively pressurizes one of the first information marking part and the second information marking part.

2. The medicine information marking device of claim 1, wherein the position moving part raises the information marking support part so that the selective pressurization by the external force supply part is implemented.

3. The medicine information marking device of claim 2, wherein each of the first information marking part and the second information marking part is a pen capable of expressing arbitrary color and includes a pen core and a case that accommodates the pen core, and
the external force supply part, in a state in which the case is accommodated in and supported by the information marking support part, pressurizes the pen core so that the pen core protrudes from the case and is exposed such that the pen core is brought into contact with the medicine packing paper.

4. The medicine information marking device of claim 3, wherein each of the first information marking part and the second information marking part further includes an adjusting part that, when the pen core is exposed from an inside of the case to the outside, maintains the exposed state, and
when the first information marking part and the second information marking part are inserted into the information marking support part, the information marking support part separates the case and the adjusting part from each other so that a function of the adjusting part is lost.

5. The medicine information marking device of claim 3, wherein each of the first information marking part and the second information marking part further includes an enclosing part which is disposed inside the case and surrounds the pen core so as to prevent the pen core from being dried and to increase its lifetime when there is no pressure applied by the external force supply part.

6. The medicine information marking device of claim 5, wherein, when the pen core is pressurized by the external force supply part, a state of the enclosing part is changed so that the pen core protrudes from the case and is exposed.

7. The medicine information marking device of claim 1, further comprising a medicine packing paper support which is positioned on a line corresponding to the external force supply part and supports the medicine packing paper so that the information on the medicines is clearly marked by the pressurized information marking part on the medicine packing paper which is brought into contact with the pressurized information marking part when one of the first information marking part and the second information marking part is pressurized by the external force supply part,
wherein, when the pressurized information marking part is brought into contact with the medicine packing paper, the medicine packing paper support is elastically changed in position by the pressurized information marking part to prevent the medicine packing paper from being cut.
